(19) United States
(12) Patent Application Publication
(10) Pub. No.: US 2008/0272278 A1
(43) Pub. Date: Nov. 6, 2008

(54) Solar Powered Light

(76) Inventors: Prashant Shewa, Yorba Linda, CA (US); Pramit Shewa, Yorba Linda, CA (US)

Correspondence Address: JOHN D. TRAN;BUUS, KIM, KUO, & TRAN, LLP, 4675 MacArthur Court, Suite 590, Newport Beach, CA, 92660, US

(21) Appl. No.: 11/743,122

(22) Filed: May 1, 2007

(51) Int. Cl. F21L 4/00

(52) U.S. Cl. 250/206; 362/183

(57) ABSTRACT

A solar lighting fixture and method thereof, is provided which comprises an outer cover lens containing a plurality of gripping protrusions that is coupled to a housing. The housing, and outer cover lens being made of hard, durable and resilient poly-carbonate like material which extends the longevity of the outer lens 3 because it is able to withstand an elongated exposure to weather conditions and normal wear and tear. Said housing contains a solar panel board comprising of a plurality of solar panels coupled to a printed circuit board such as a PCM board. PCM board being electrically coupled to at least one light emitting diode or light and is also electrically connected to at least one condenser battery. Said solar panels convert sunlight into electrical power which is stored within the condenser battery until night time when such power is released resulting in the activation of the LED's which allows the solar lighting unit to illuminate. The use of condenser battery allows the solar lighting unit to exhibit an increased life-span and allows for maintenance free operation. The solar lighting unit is air-tight and contains no removable parts.

### FIELD OF THE INVENTION

The field of the invention is solar powered lights. In particular, solar powered lighting units that are used to illuminate outdoor areas including but not limited to walkways, steps, sidewalks, street intersections, and patio areas.

### BACKGROUND OF THE INVENTION

It can be appreciated, that solar powered units or cells have been around for many years. Typically, these solar powered units incorporate the use of solar panels to maintain charge in batteries during daytime and then resulting in the batteries powering a light or lights at night which provides illumination. This is beneficial since the use of solar power eliminates the need that each unit be required to use traditional electrical power which reduces electricity costs and provides more flexibility in the placement of each unit. It is also known for a solar powered unit to incorporate a built-in timer that turns the light ON and OFF within a certain daily time cycle and allow for the solar powered unit to be sensitive to light which allows the unit/cell to automatically turn ON and OFF depending on if it is day or night time. Presently, current solar powered units, such as described in U.S. Pat. No. 6,339,188 (herein incorporated by reference as the “Voelkner Patent”), are housed in typical “brick” style housing that can be placed in outdoor walkways or footpaths that would benefit from illumination. However, the Voelkner Patent and similar solar powered units suffer from a variety of limitations, including requiring the use of a batteries or rechargeable batteries which require on-going maintenance and replacement of batteries after a short period of use. Additionally, as a result of the past and current solar powered unit's dependency on batteries and rechargeable batteries, the solar powered unit's housing is require to contain a removable cover in order to allow the solar powered unit to be properly maintained. The limitations of incorporating a removable cover or other removable components in a solar powered unit result in an increase of normal wear and tear of outdoor weather conditions and usage upon the solar powered unit. In addition, because of the limitations of using batteries or rechargeable batteries, the past and current solar powered units have only a short life span, typically lasting only a few months or several years.

### SUMMARY OF THE INVENTION

It is the object of the present invention to overcome or reduce the limitations addressed above. The present invention comprises of a solar powered unit having a fully self contained housing including an un-removable exterior cover lens, outwardly gripping protrusions, a printed circuit board, LED lights, a diffusion lens, and condensers for electrical storage. The contemplated solar powered unit's size and shape can vary to accommodate different situations, such as shapes in the sizes of bricks of small circles to illuminate an outdoor walkway or stairwell. Alternatively, the contemplated solar powered unit may be manufactured in a larger shape to accommodate public walking intersections and commercial drive-ways. Further, the contemplated solar powered unit incorporates condensers because they have a longer life span as compared to typical batteries or rechargeable batteries which result in no maintenance or replacement for the life span of the present invention, typically, between 20-25 years.

Another object of the invention to provide a solar powered unit housing that has no removable parts;

It is another object of the invention to provide an exterior cover that contains gripping protrusions that help reduce or eliminate slippage when the solar powered unit is walked upon;

It is another object of the invention to provide a solar lighting fixture that does not require the use of an ON or OFF switch.

### BRIEF DESCRIPTION OF THE DRAWING

FIG. 1 is a perspective view of the solar powered unit according to an aspect of the inventive subject matter;

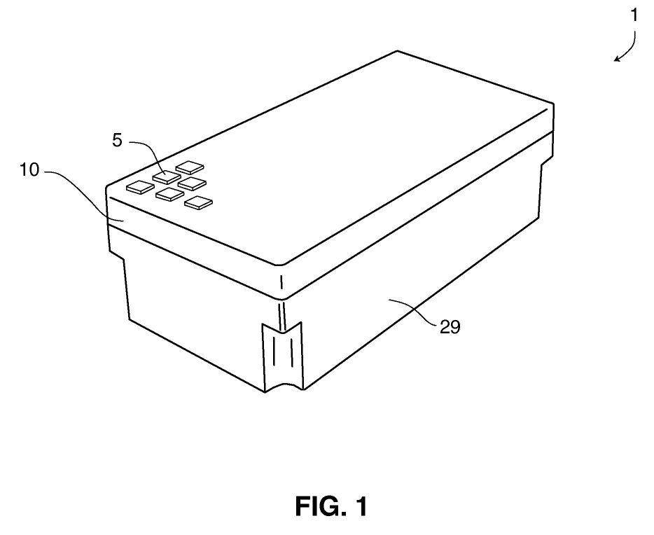

FIG. 2 is a side view of the solar powered unit according to an aspect of the inventive subject matter;

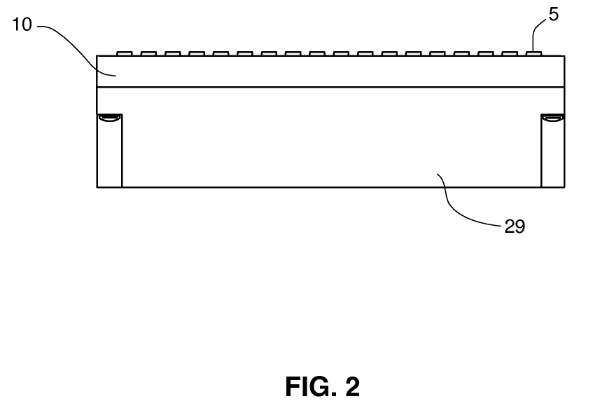

FIG. 3 is a front view of the solar powered unit according to an aspect of the inventive subject matter;

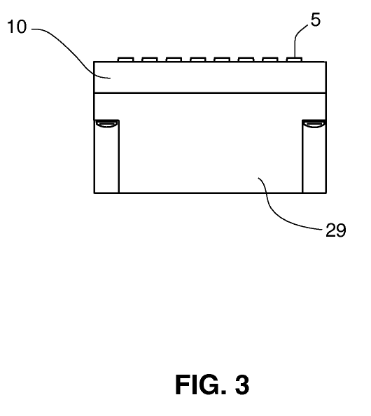

FIG. 4 is a top-down view of the solar powered unit according to an aspect of the inventive subject matter;

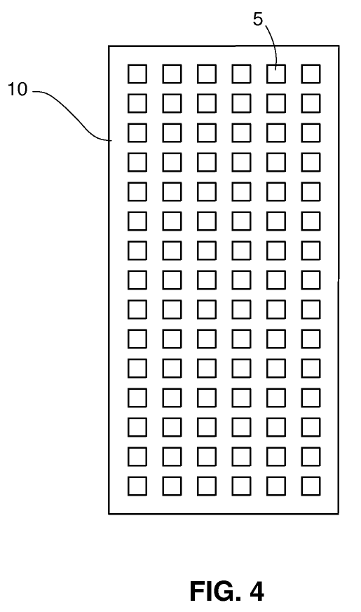

FIG. 5 is a bottom view of the solar powered unit according to an aspect of the inventive subject matter;

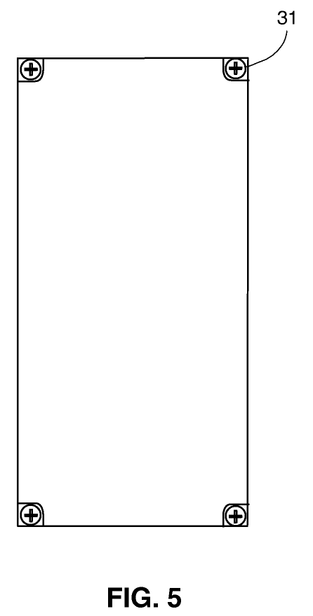

FIG. 6 is an exploded view of the solar powered unit according to an aspect of the inventive subject matter;

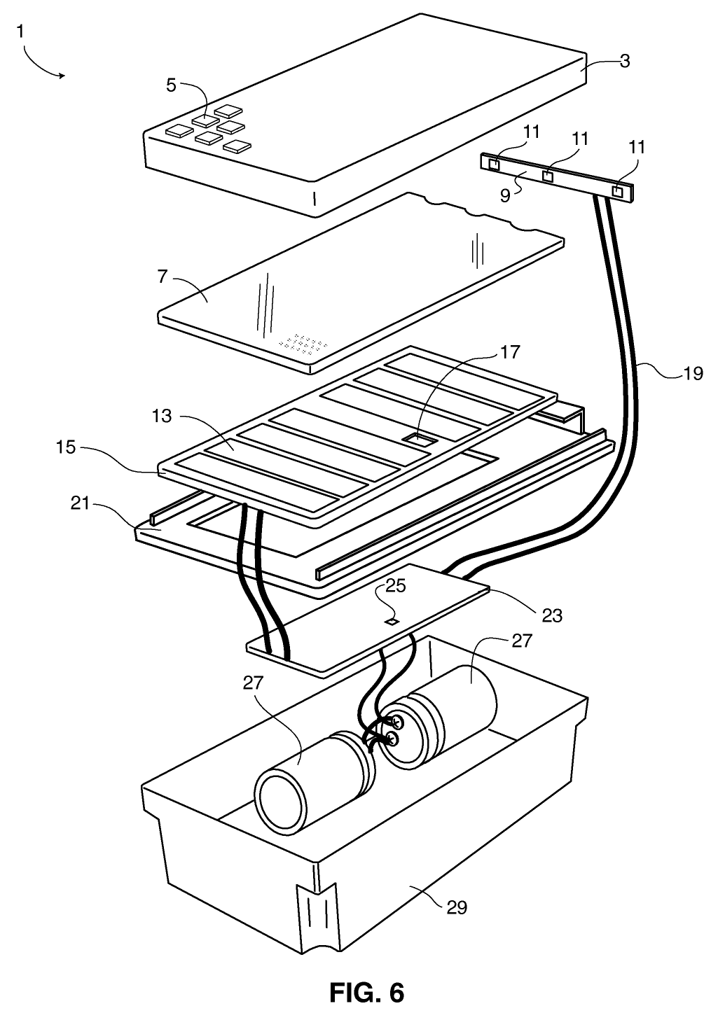

FIG. 7 is a view of the solar powered unit being shown in one example of a particular use; according to an aspect of the inventive subject matter;

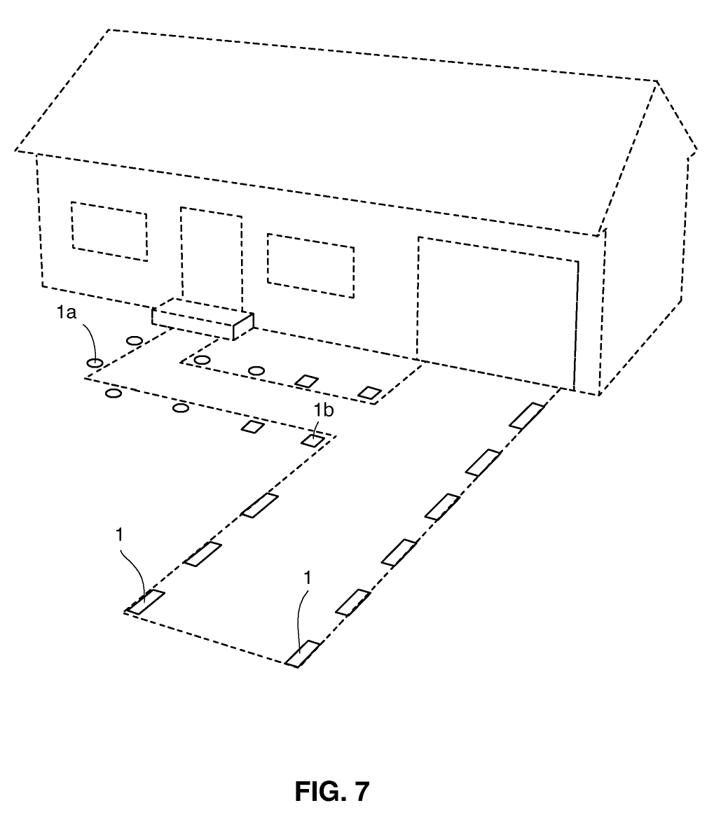

FIG. 8 depicts views of the solar powered unit being shown in different configurations and sizes; according to an aspect of the inventive subject matter.

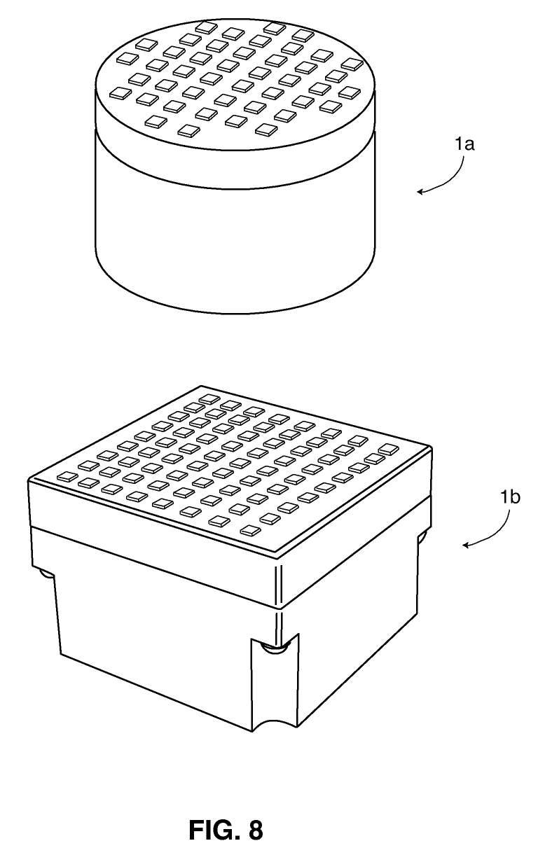

### DETAILED DESCRIPTION

Referring to the drawings, a housing 29, having been made by a hard, durable and resilient poly-carbonate like material, is coupled with an outer cover lens 3 to provide an air tight solar panel unit 1. In the present embodiment, it can be appreciated that the outer cover lens 3 is transparent or clear in nature to maximize the illuminating aspects of the solar lighting unit. The outer cover lens 3 is also made of hard, durable and resilient poly-carbonate resin like material which extends the longevity of the outer lens 3 because it is able to withstand an elongated exposure to weather conditions and normal wear and tear. The present embodiment incorporates a plurality of gripping protrusions 5 which reduce or prevent slippage when the present invention is walked upon. Contained within the housing 29 is at least one condenser battery 27 that is coupled to the solar panel board 15 which comprise of a plurality of solar panels 13. The condenser battery 27 is capable of storing electrical storage when exposed to sunlight for an elongated period of time and which requires no replacement and maintenance. The condenser battery 27 is coupled to a printed control circuit such as a PCM board 23 and comprises of a photoreceptor 25, which is capable of determining whether it is day or night time is coupled to said PCM board 23. At least one light emitting diode or light 11 is coupled to a control frame strip 9 which is coupled to the PCM board 23. The solar panel board 15 contains an opening 17 which allows the photoreceptor 25 to access sunlight to determine when to automatically turn on and off the solar light unit. A divider plate 21 separates the solar panel board 15 and the PCM board 23 and provides an opening in which the solar panel board 15 can be coupled to the PCM board 23. The divider plate 21 also assists in stabilizing and securing the solar panel board in place.

In typical use, during the daytime the solar panels 13 convert sunlight into electrical power which is stored within at least one battery condenser 27. During the daytime, the photoreceptor 25 provides instruction by way of the PCM board 23 which automatically turns off the solar lighting unit. At night time, the photoreceptor 25 provides instruction by way of the PCM board 23 which automatically provides the condenser battery 27 to release its stored electrical power which powers the LED lights, resulting in automatically turning on the solar lighting unit. The light or illumination arising from the LED lights are diffused or dispersed by a diffusion lens 7, which provide an even and uniform distribution of illumination. The illumination thereby is seen through the transparent or clear cover lens 3.

Because of the novelty of using a condenser battery 27 which allows for maintenance free operation and longer life spans, the present invention not only can be used for private use, but may be used in public walkways and streets which often times are difficult to access due to pedestrian and automobile traffic.

Thus, specific embodiments and applications of the Storage System have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

What is claimed is:

1. A solar lighting fixture comprising:
a housing;
a solar panel disposed within the housing wherein the solar panel generates electricity when exposed to a light source;
a lighting unit disposed within the housing and powered by the electricity to give off light;
a battery condenser coupled to the solar panel; and
wherein the battery condenser is capable of storing an electric charge.

2. The solar light fixture of claim 1, wherein the housing includes transparent portions allowing light to pass through.

3. The solar light fixture of claim 2, wherein the lighting unit includes at least one light-emitting diode.

4. The solar light fixture of claim 3 further comprising a control circuit disposed within the housing and a photoreceptor coupled to the control circuit, wherein the photoreceptor detects a level of brightness in an environment exterior to the housing, and wherein the lighting unit is controlled by the control circuit based on a predetermined level of brightness in the environment exterior to the housing.

5. The solar light fixture of claim 4, wherein the control circuit is a PCM board.

6. The solar light fixture of claim 5, wherein the housing has a shape and dimension that resembles at least one of a flooring material, a building material, a garden fixture, and a household fixture.

7. The solar light fixture of claim 6, wherein the housing has a shape and dimension that resembles at least one of a brick, a tile, a paving stone, a glass block, a cinder block, a hardwood floor modular piece, a lumber piece, a slab, a pole, and a rock.

8. The solar light fixture of claim 5, wherein the housing is self-contained, and moisture-sealed, such that the solar light fixtures is capable of maintenance-free operation for at least 5 years while permanently set in a structure.

9. The solar light fixture of claim 8, wherein the solar light fixtures is capable of maintenance-free operation for at least 10 years while permanently set in a structure.

10. The solar light fixture of claim 9, wherein the solar light fixtures is capable of maintenance-free operation for at least 20 years while permanently set in a structure.

11. The solar light fixture of claim 8, wherein the structure is one of a wall, a ground, a flooring, a driveway, a sidewalk, a road, a bridge, a building, and a permanent fixture.

12. The solar light fixture of claim 11, wherein the transparent portion is a top side of the housing, and the exterior side of the transparent portion has an anti-skid surface texture, and the housing includes a container-like bottom piece with raised wall to provide an inner space sufficiently large to house the solar panel, the battery condenser, and the control circuit.

13. The solar light fixture of claim 12, wherein said transparent portion of the top side of the housing consists of a hard, durable and resilient poly-carbonate like material;

14. A method of providing sidewalk lighting by using a solar light fixture as recited in claim 12, by integrating the solar light fixture into a sidewalk construction such that the solar light fixture is exposed to light during the day, and capable of giving off light during the night.

15. The method of claim 13, wherein the solar light fixture is set in the sidewalk and is substantially flush with surrounding sidewalk surfaces.

16. A modular building material, comprising:
a modular piece having a hollow interior space, and an exterior shape and size that resembles at least one member selected from the group consisting of a brick, a tile, a paving stone, a glass block, a cinder block, a hardwood floor modular piece, a lumber piece, a slab, a pole, and a rock;
a solar module disposed within the hollow space to generate electricity from a light source;
a control circuit coupled to the solar module;
a LED coupled to the control circuit;
a photoreceptor coupled to the control circuit; and
a capacitor coupled to the solar module and is capable of storing a charge of electricity.

17. The modular building material of claim 15, wherein the modular piece is self-contained and moisture sealed, and is capable of being permanently cemented into a construction project, and is capable of working as a light fixture while permanently cemented into the construction project for at least 5 years without the need to replace the capacitor.

18. The modular building material of claim 16, wherein the modular piece is capable of working as a light fixture while cemented into the construction project for at least 15 years without the need to replace the capacitor.

19. The modular building material of claim 17, wherein the construction project is at least one of a sidewalk, a flooring, a wall, a bridge, and a permanent fixture.

20. A method of marketing a lighting fixture, comprising the steps of:
providing a solar light unit having a solar module, electricity storage unit, a control circuit, and a LED;
wherein the solar light unit is capable of continuous operation for at least 5 years without replacing the electricity storage unit; and
providing a written instruction that the solar light unit can be integrated with a surrounding man-made environment.

21. The method of claim 19, wherein the electricity storage unit includes at least one battery condenser.

22. The method of claim 20, wherein the surrounding man-made environment is one of a wall, a ground, a flooring, a driveway, a sidewalk, a road, a bridge, a building, and a permanent fixture.

23. The method of claim 21, wherein the solar light unit has a housing that has at least one portion that is light-transparent, and the solar light unit has a light sensor coupled to the control circuit, wherein the light sensor detects the level of brightness outside of the solar light unit, and where the detected level of brightness determines whether the LED should be turned on or off.

24. The method of claim 22, wherein the solar light unit is self-contained, moisture-proof, and capable of continuous operation for at least 15 years without replacing the electricity storage unit, and wherein the housing is comprised of a top lid sealingly fastened to a bottom container piece.
